(19) United States
(12) Patent Application Publication
(10) Pub. No.: US 2025/0342634 A1
(43) Pub. Date: Nov. 6, 2025

(54) SYSTEM AND METHOD FOR REALTIME EMOTION DETECTION AND REFLECTION

(71) Applicants: Chantal Bacon, Palm Beach Gardens, FL (US); Venkatesh Eganti, Hyderabad (IN); Vishnu Gadwala, Velgode (IN); Ben Bacon, Palm Beach Gardens, FL (US)

(72) Inventors: Chantal Bacon, Palm Beach Gardens, FL (US); Venkatesh Eganti, Hyderabad (IN); Vishnu Gadwala, Velgode (IN); Ben Bacon, Palm Beach Gardens, FL (US)

(21) Appl. No.: 19/198,552

(22) Filed: May 5, 2025

Related U.S. Application Data
(60) Provisional application No. 63/642,143, filed on May 3, 2024.

(51) Int. Cl. G06T 13/00; G06V 10/70; G06V 20/40; G06V 40/16; G10L 25/30; G10L 25/57; G10L 25/63

(52) U.S. Cl. CPC G06T 13/00; G06V 10/70; G06V 20/40; G06V 40/174; G10L 25/30; G10L 25/57; G10L 25/63

(57) ABSTRACT

A digital character emotion response system is disclosed, incorporating modules configured to process audio and video streams to predict emotional states. The system features an audio processing module, a video processing module, a fusion module for integrating audio and video features, and a machine learning module with an LSTM model for analyzing the combined data to predict and output emotional states with confidence scores.

### FIELD OF THE INVENTION

This disclosure relates generally to the field of digital interaction and emotional response systems. More specifically, it pertains to a system capable of processing audio and video inputs to simulate human-like responses by digital characters in real-time, through continuous analysis of multimodal input streams, including audio and video data.

### BACKGROUND OF THE INVENTION

The present disclosure pertains to the field of artificial intelligence (AI), with a specific focus on emotion recognition systems that integrate audio and video data to facilitate real-time interactive responses by digital avatars.

The real-time processing of audio and video inputs is relevant across multiple industries such as entertainment, retail, healthcare, and security, promoting extensive research and development efforts. Traditionally, systems processed audio and video data streams independently using predefined programmed logic. Audio processing in these systems typically involves steps such as noise filtering, segmentation, and feature extraction, focusing on aspects like pitch, rate of speech, and energy levels. These processes employ various digital signal processing (DSP) techniques aimed at enhancing signal clarity, which is particularly critical in environments where clear communication is pivotal.

Concurrently, video processing technologies have advanced significantly, driven by improvements in video capture equipment and computational power. Techniques such as facial landmark detection, timing of emotions in video frames, and analysis of body language play essential roles. These technologies enable the interpretation of human gestures and facial expressions to infer emotional states or intentions. Despite advancements in audio and video processing separately, the integration of these inputs into a cohesive system for real-time interaction has been limited. Earlier approaches typically handled audio and video streams in isolation, which often resulted in disjointed and inaccurate interpretations of a user's emotional state and intentions.

Human-computer interaction has traditionally relied on text, voice commands, and structured inputs without significant regard for the user's emotional state. While advancements in natural language processing and computer vision have improved the responsiveness of digital systems, these technologies often lack the ability to perceive and adapt to the emotional nuances of human communication. Consequently, interactions with digital systems can feel rigid, impersonal, and disconnected, leading to diminished user engagement and satisfaction.

Existing emotion detection systems typically focus on singular modalities, such as analyzing either vocal tone or facial expressions in isolation. However, human emotional expression is inherently multimodal, involving complex interplays between voice, language, facial expressions, body posture, and environmental context. Systems that fail to integrate these cues holistically are limited in their ability to accurately interpret the user's true emotional state.

The introduction of machine learning techniques, particularly Long Short-Term Memory (LSTM) networks, has facilitated more accurate synthesis of audio and video data to predict emotional states. These systems, trained on extensive datasets of labeled emotional speech and corresponding facial expressions, are capable of detecting complex patterns and correlations between audio-visual cues and human emotions. Existing systems across various domains like personal assistants, retail, healthcare, and autonomous vehicles employ emotion recognition technology; however, they generally lack a unified, real-time processing framework capable of dynamically consistent responses. This limitation hampers the creation of fully immersive, AI-driven systems with a digital avatar.

A significant challenge remains in developing systems that provide a sophisticated level of interaction closely mimicking human responses. There is an increasing demand for natural, intuitive interactions with AI systems, necessitating seamless integration of emotional recognition and response generation capabilities. This demand is particularly pronounced in the AI digital assistant, where there is a critical need for digital avatars that interact with users in a manner that is virtually indistinguishable from human-to-human interaction.

Furthermore, while digital avatars and conversational agents have become increasingly lifelike, they often lack emotional intelligence, resulting in responses that are contextually appropriate but emotionally tone-deaf. Current architectures rarely combine real-time emotion recognition with dynamic emotional adaptation in a seamless and interactive manner.

Moreover, most conversational systems operate within confined domains without dynamic interaction with external tools or services. This limits their ability to perform meaningful actions on behalf of the user in emotionally aware ways, such as responding empathetically to a stressed user while simultaneously managing emails, scheduling, retrieving location information, or integrating with CRM systems.

Therefore, there is a need for a system that effectively merges audio and video processing technologies in a real-time, integrated framework to accurately interpret and respond to human emotions and intentions. This system should allow for dynamic interaction with digital avatars, achieving a level of responsiveness and depth comparable to natural human interactions, thereby filling the existing gap and advancing the capabilities of intelligent interactive systems.

### BRIEF SUMMARY OF THE INVENTION

The present invention provides among other things a digital character emotion response system that can comprise a receiver configured to receive an audio stream and a video stream. An audio processing module that can be configured for noise reduction, feature extraction, and preprocessing of vocal characteristics, while a video processing module can be adapted for facial landmark detection, body language analysis, emotion timing, and preprocessing. A fusion module amalgamates features from both the audio processing module and the video processing module to form a unified data representation. Furthermore, a machine learning module includes a Long Short-Term Memory (LSTM) model can be configured to analyze the unified data representation to predict emotional states of a person and output these predictions with associated confidence scores.

The fusion module of the system can be optionally configured to perform either feature-level or decision-level integration of the audio and video features, enhancing the robustness and accuracy of emotion recognition. The system can further include an output module configured to adjust the digital character's responses based on the predicted emotional states. Specifically, the output module may adjust vocal attributes such as pitch and tone, dynamically render the digital character's facial expressions, and modify the character's body language and gestures to provide a realistic and responsive interaction experience with users.

The system implements a Continuous Visual Context Accumulation Layer that captures sequential frames from the active webcam input at controlled intervals, allowing it to build a persistent visual memory without overwhelming computational resources. This architecture employs parallel capture and buffer management, where a secondary execution thread operates asynchronously to the main inference pipeline, continuously capturing additional frames at a higher sampling frequency. The system further incorporates a Dynamic Visual Query Resolution Layer that provides instantaneous, user-driven visual understanding when a user asks a visual question such as “Identify this object” or “Describe the environment.” In these instances, the system triggers a high-priority frame capture that is synchronously transmitted alongside the user's natural language query to the Vision-Language Model for immediate multimodal inference.

Beyond mere conversational interactions, the system integrates orchestration capabilities with external services and tools. Through secure API integrations, it can access and manage user emails through external platforms; retrieve, interpret, and utilize real-time location data; interface with customer relationship management (CRM) systems for user task management, lead handling, or service inquiries; and interact with calendars, task management applications, and other productivity tools. Importantly, these external actions are performed not simply based on content-driven commands but in an emotionally contextualized manner. For instance, a stressed or frustrated emotional state detected from the user may alter how the system prioritizes reminders, composes emails, or manages scheduling conflicts.

To ensure global applicability, the system incorporates multilingual capabilities at all levels of operation. The audio emotion recognition models are trained to detect emotional prosody across multiple languages, ensuring that tone and vocal variations unique to different languages and cultures are accurately interpreted. The semantic analysis pipeline is capable of understanding and extracting sentiment from multilingual speech inputs, preserving emotional nuance across linguistic boundaries. The system can generate emotionally sensitive responses in the user's preferred language, maintaining both linguistic accuracy and emotional appropriateness.

The digital character emotion response system achieves real-time stream simulation for Vision-Language Models traditionally constrained to discrete frame analysis by employing a synchronized multithreaded buffering and dispatch mechanism. It maintains zero-context-loss across inference cycles through proactive buffered frame management, supports dynamic contextual visual query handling without disrupting continuous environmental monitoring, and optimizes computational resource utilization through disciplined frame rate regulation and asynchronous operations. Together, these innovations empower the system with multimodal session awareness, allowing it to interpret and respond to users in a manner that more closely approximates human-like perceptual and cognitive behaviors.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” “or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 is a block diagram showing a logical component arrangement for processing audio and video inputs to produce rendered emotional responses using an avatar engine; and

FIG. 2 is a block diagram depicting a high-level architecture that details the processing of audio and video streams through respective decoders and vectorization modules, leading to emotion prediction and response generation in an avatar processing engine.

FIG. 3 is a sequence diagram illustrating the Continuous Visual Context Accumulation Layer, a vision system architecture designed to enable near real-time emotional state detection and environmental situational awareness using Vision-Language Models (VLMs);

FIG. 4 is a diagram of the Dynamic Visual Query Resolution Layer, engineered to provide instantaneous, user-driven visual understanding tightly synchronized with the session's accumulated emotional and environmental context.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

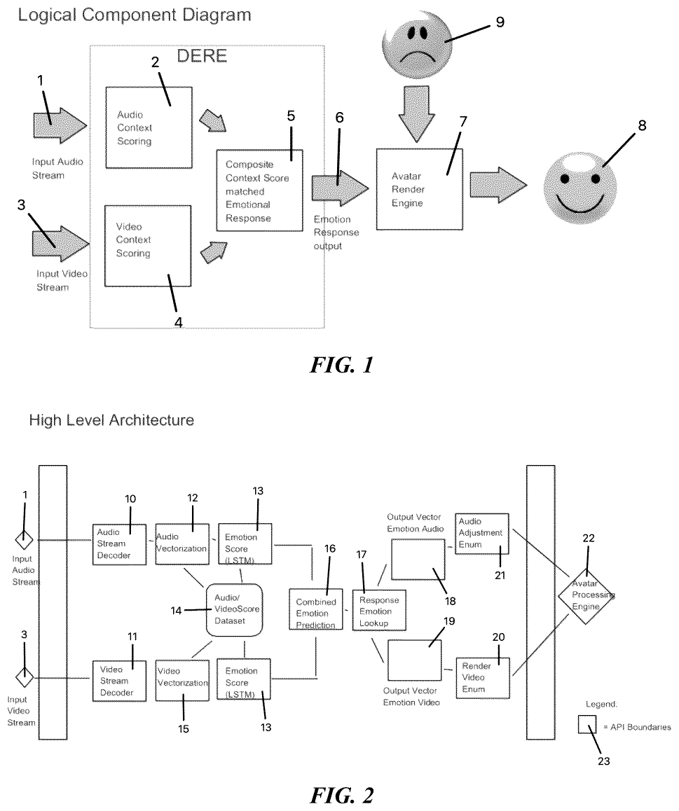

Referring initially to FIG. 1, the diagram illustrates a system for processing and rendering emotional responses based on input audio and video streams. Input audio stream 1 and input video stream 3 are separately introduced to audio context scoring 2 and video context scoring 4, respectively. These components function to evaluate the contextual attributes of the respective input streams. The outputs from audio context scoring 2 and video context scoring 4 are subsequently converged to formulate a composite context score matched emotional response 5. This composite score is then used to produce an emotional response output 6, manifested through an avatar by leveraging an avatar render engine 7. This emotional render can result in the output of either a correct emotional response from the avatar render 8 or a wrong emotional response from the avatar render 9, indicating the system's accuracy in emotional conveyance.

The system can further comprise a computing device comprising a processor, a memory in communication with the processor, the memory storing instructions that, when executed by the processor, cause the processor to perform a method. The method can comprise receiving a digital image, applying a machine learning model to the received digital image to identify a set of features within the digital image, comparing the identified set of features with a features database, and generating an output based on the comparison.

Additionally or alternatively, the image may be processed using a vision language model. Vision language models (VLMs) are powerful AI systems that can process and understand both images and text together by combining two key components: a vision encoder and a language model. The vision encoder processes image data, while the language model handles text. The vision encoder (often a convolutional neural network or transformer) first analyzes an image and converts it into a mathematical representation called feature vectors or embeddings. These embeddings capture the visual elements in the image-objects, people, scenes, colors, shapes, and their relationships.

Next, these visual embeddings are projected into the same mathematical space as the language model's word embeddings. This crucial step allows the visual information to be “understood” by the language model. The language model (typically a transformer-based architecture) can then process both the visual information and any text input together. This integration enables the VLM to reason about what it “sees” and respond to questions or generate descriptions about the image. Advanced VLMs are trained on massive datasets containing image-text pairs, learning the relationships between visual content and language descriptions. This training helps them develop an understanding of visual concepts, object relationships, and how to describe visual information in natural language. VLMs can perform tasks such as image captioning, visual question answering, object recognition, and understanding complex visual scenes-all while communicating about these visual inputs using natural language.

For example, during an interaction with the system, a user interacting with a virtial representative for an automotive manufacturer may ask a question about an automotive component in the user's hand. The system may recognize that a visual question has been asked and take an image of the user during the visual question and mark the image as high priority. The VLM may analyze the image and use historical context to identify the component referred to by the user and provide a response specific to the identified component.

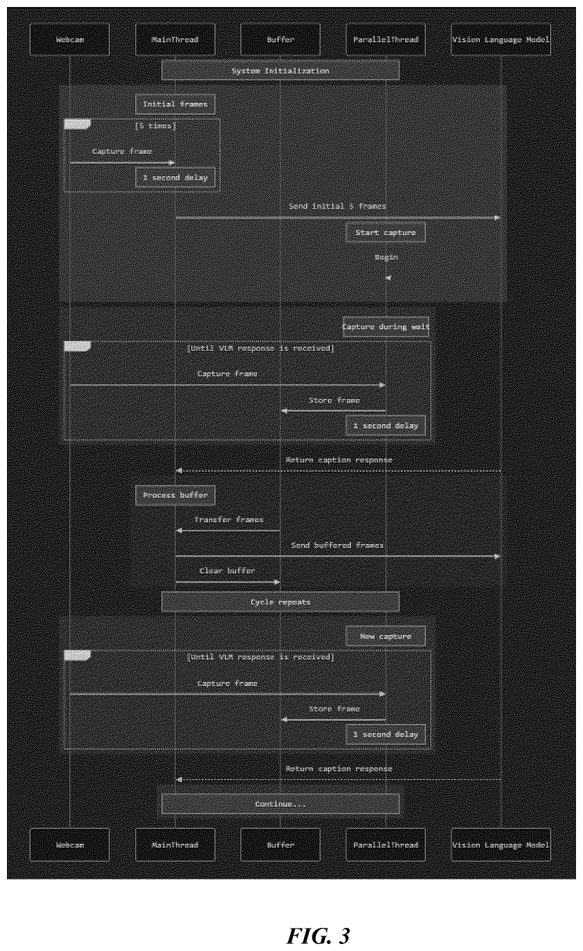

Referring now to FIG. 2, a more elaborate architecture for emotional response processing based on audio and video inputs is provided. It incorporates additional granularity in the forms of audio stream decoder 10 and video stream decoder 11, which initially process the input audio stream 1 and input video stream 3, respectively. Following decoding, audio vectorization 12 and video vectorization 15 are applied, forming detailed data representations suitable for emotional analysis. Both streams contribute to emotion scores via an LSTM-based system, as specified by emotion score (LSTM) 13. The results are then incorporated into an audio/video score dataset 14, laying groundwork for a combined emotion prediction 16. This prediction cues a response emotion lookup 17, which identifies appropriate emotional responses that are then delivered as output vector emotion audio 18 and output vector emotion video 19. Changes specific to the outputs can be further tailored via audio adjustment enum 21 and render video enum 20. These processes are encapsulated within an avatar processing engine 22, suggesting an integrated approach to managing and rendering emotional responses, all of which are defined by API boundaries 23 to delineate modular components.

The system maintains two distinct yet interrelated emotional context histories. The auditory emotional context history is managed by the audio processing module, which continuously captures and processes live audio streams from the user. Emotional inference is achieved through two synergistic analyses: prosodic analysis, where a speech emotion recognition (SER) model evaluates paralinguistic features such as tone, pitch, intensity, and rhythm to infer emotional cues like anger, happiness, sadness, anxiety, or neutrality; and semantic analysis, where an integrated natural language processing (NLP) engine examines the semantic content of the spoken words to detect emotional undertones based on specific language, phrasing, sentiment polarity, and contextual use of expressions.

The visual emotional context history may operate in parallel through the video processing module, which captures continuous video streams. Visual emotion recognition is conducted using on-premise deployed large vision-language models (VLMs), such as Pixtral-12B or LLaVA. These VLMs analyze facial expressions, micro-expressions, body gestures, and posture; understand the user's broader environment by interpreting objects, activities, and settings visible through the webcam feed; and integrate environmental awareness into the emotional inference pipeline to better contextualize user states.

Referring to FIG. 3, which illustrates the Continuous Visual Context Accumulation Layer, a vision system architecture designed to enable near real-time emotional state detection and environmental situational awareness using VLMs, processing discrete frames rather than continuous video stream interpretation. The proposed architecture achieves persistent contextual visual understanding through a hybrid layered system comprising Continuous Visual Context Accumulation and Dynamic Visual Query Resolution, engineered to simulate real-time analysis while maintaining operational efficiency and full context preservation.

The system initializes by capturing a predefined batch of five sequential frames from the active webcam input, spaced at controlled intervals of approximately 1 second per capture. These initial frames are immediately packaged and transmitted to the Vision-Language Model (e.g., Pixtral-12B, LLaVA) for batch inference to establish a baseline environmental and emotional context.

For parallel capture and buffer management, upon initialization, a secondary parallel execution thread is spawned. This thread operates asynchronously relative to the main inference pipeline and continuously captures additional frames at a higher sampling frequency (approximately 0.8 seconds interval) into a designated Frame Buffer. Buffered frames are timestamped and ordered to maintain temporal integrity.

For inference response handling and buffer flush, once the VLM returns the inference result for the current batch, the main thread immediately packages the accumulated buffered frames and the frames are transmitted as the next inference batch to the VLM. Upon successful dispatch, the frame buffer is flushed, and the cycle recommences.

Beyond mere conversational interactions, the system integrates orchestration capabilities with external services and tools. Through secure API integrations, it can access and manage user emails through external platforms; retrieve, interpret, and utilize real-time location data; interface with customer relationship management (CRM) systems for user task management, lead handling, or service inquiries; and interact with calendars, task management applications, and other productivity tools. Importantly, these external actions are performed not simply based on content-driven commands but in an emotionally contextualized manner. For instance, a stressed or frustrated emotional state detected from the user may alter how the system prioritizes reminders, composes emails, or manages scheduling conflicts.

To ensure global applicability, the system incorporates multilingual capabilities at all levels of operation. The audio emotion recognition models are trained to detect emotional prosody across multiple languages, ensuring that tone and vocal variations unique to different languages and cultures are accurately interpreted. The semantic analysis pipeline is capable of understanding and extracting sentiment from multilingual speech inputs, preserving emotional nuance across linguistic boundaries. The system can generate emotionally sensitive responses in the user's preferred language, maintaining both linguistic accuracy and emotional appropriateness.

The objective of this architecture is to establish a persistent visual memory and emotional situational awareness across the session without overwhelming the computational pipeline or exceeding the VLMs' discrete processing capabilities.

The system may include additional features such as Zero-Loss Context Preservation, where no intermediate emotional expressions, user gestures, or environmental events are lost between inference cycles due to the proactive buffering strategy, and Real-Time Perception Illusion, where the system's structured timing and immediate batch switching simulate a continuous real-time stream, delivering a seamless user experience without exceeding the discrete frame-processing limitations of the VLM.

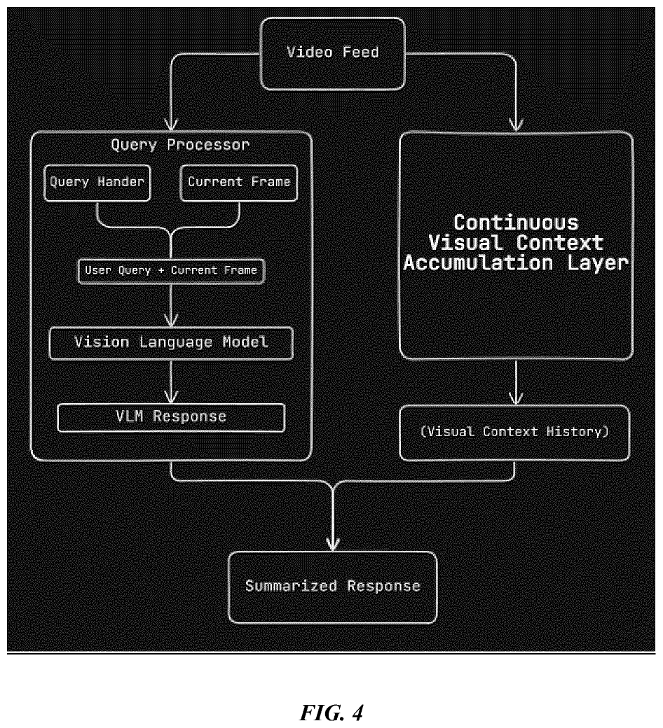

Referring to FIG. 4, a Dynamic Visual Query Resolution Layer is provided. The Dynamic Visual Query Resolution Layer is engineered to provide instantaneous, user-driven visual understanding tightly synchronized with the session's accumulated emotional and environmental context.

Upon detecting a user-initiated visual query—whether through spoken input or textual command—such as “Identify this object” or “Describe the environment,” the system immediately triggers a high-priority frame capture from the active webcam feed. This newly captured, query-specific frame is then synchronously transmitted alongside the user's natural language query to the Vision-Language Model (VLM) for immediate multimodal inference, ensuring that the input reflects the exact moment of the user's inquiry with minimal temporal drift.

Following the VLM's inference, the system leverages an integrated summarization and synthesis engine to generate the final response. This engine need not rely solely on the instantaneous frame; rather, it intelligently fuses the immediate inference output with the historical emotional and environmental context accumulated continuously by the system. As a result, the system produces a fluid, highly informed reply that maintains both immediate visual relevance and session-level coherence.

Architecturally, this design guarantees temporal alignment by ensuring that dynamic frames are captured within milliseconds of user query initiation, achieving the highest possible correlation between user intent and system perception. Furthermore, context-aware augmentation techniques are employed to enrich the system's replies, combining real-time interpretation with broader visual memory, significantly enhancing the depth, realism, and naturalness of responses.

The Dynamic Visual Query Resolution Layer achieves real-time stream simulation for VLMs traditionally constrained to discrete frame analysis by employing a synchronized multithreaded buffering and dispatch mechanism. It maintains zero-context-loss across inference cycles through proactive buffered frame management, supports dynamic contextual visual query handling without disrupting continuous environmental monitoring, and optimizes computational resource utilization through disciplined frame rate regulation and asynchronous operations. Together, these innovations empower the system with multimodal session awareness, allowing it to interpret and respond to users in a manner that more closely approximates human-like perceptual and cognitive behaviors.

Collectively, FIG. 1 through FIG. 4 describe a technology framework from a high-level concept in FIG. 1 to a more detailed implementation in FIG. 2, and specialized architecture components in FIG. 3 and FIG. 4. This refined structure facilitates the understanding and application of complex background processes such as decoding, vectorization, and emotion score computation required to effectively render accurate emotional responses in digital avatars driven by multimodal input sources. This represents a method and system for emotional state determination and avatar-based response visualization, providing a multimodal interaction system that can be adapted across various digital communication platforms.

In embodiments, the system can comprise several components which are configured to optimize the interpretation and response generation related to human emotional states. The system can comprise a receiver wherein the receiver is configured to accept two types of input streams—an audio stream and/or a video stream. These streams capture the full spectrum of human expressions and acoustic nuances involved in interpersonal communication. An audio processing module can be tasked with handling the audio stream and includes several sub-components such as, for example, noise reduction which can filter out irrelevant and distracting background sounds from the audio stream to ensure clarity and accuracy of the vocal characteristics being analyzed. A feature extraction can recognize and isolate various vocal characteristics such as pitch, volume, timbre, speaking rate, and vocal inflections. A preprocessing unit can extract features that can be normalized and scaled to prepare the data for effective integration and analysis in subsequent stages.

The video processing module can be parallel to the audio processing wherein the module can process the video stream and focus on visual aspects of human interaction. The video processing module can comprise a facial landmark detection, body language analysis, emotion timing and video preprocessing, including VLM processing. The facial landmark detection can utilize computer vision techniques to track critical facial points which aid in recognizing facial expressions. The body language analysis can complement the facial data by analyzing body movements and posture to provide a comprehensive view of the person's emotional state. The emotion timing can segment the video to align with shifts in emotion evident in facial and bodily changes. And the video preprocessing can refine the video data to emphasize features that are significant for an accurate emotional assessment.

In embodiments, a fusion module can post-process combining feature sets derived from the audio and video processing modules. The fusion module can be executed through various methods such as simple data concatenation or more complex integrations like feature-level or decision-level. This integration aims to enhance the robustness and accuracy of the system's emotion recognition capabilities. The machine learning module can have a Long Short-Term Memory (LSTM) model, which can analyze the unified data representation provided by the fusion module. The LSTM model is trained to correlate specific patterns in the audio-visual data with corresponding emotional states, and its outputs include predictions of the person's emotional state with associated confidence scores.

The system can include several output modules that can adjust and render the digital character's responses based on the predicted emotional state such as a vocal response adjustment which modifies the character's vocal attributes such as pitch and tone to suit the emotional context of the interaction, a facial rendering wherein it can dynamically generate the character's facial expressions to align with the recognized emotional state and a body language rendering which can adjust the character's gestures and body language, enhancing the realism and appropriateness of the response.

A dynamic emotion response engine (DERE) which can predict emotional state by the LSTM network wherein the DERE adjusts the digital metahuman's responses by scoring an incoming stream and sampling at a customizable rate. Adjustments can be made in real-time to the metahuman's facial expressions, body postures, and vocal attributes according to the inferred emotional context of the interacting user. Each emotional state prediction (e.g., happiness, sadness, anger, neutrality) is associated with a confidence score that guides the response intensity and specificity. The system can have an output generation wherein the outputs of the system can involve the predicted emotional states of the avatar, which inform how the DERE adjusts the avatar's responses to align more closely with the user's displayed emotions. This process effectively personalizes the interaction, enhancing user engagement and satisfaction.

The operation of the digital character emotion response system involves several steps encapsulated in a method that guides the dynamic interaction of a digital character with a human user. This method includes receiving, processing, and integrating audio and video streams. Employing machine learning techniques to analyze the integrated data. Outputting emotional state predictions with corresponding confidence scores. Adjusting and rendering the digital character in real-time based on these predictions. This structured approach allows for seamless real-time performance, making the system suitable for various applications requiring interactive digital human representations across industries such as entertainment, retail, healthcare, and more. The modular nature of the system provides flexibility and adaptability, catering to the needs of diverse operational environments.

In another embodiment, a method implemented by a computer system for image processing can include capturing an image using an image sensor, transmitting the captured image to a processor, utilizing a pre-trained neural network on the processor to extract features from the image, comparing the extracted features with a database of known features, and outputting a result indicating whether the extracted features match any features in the database.

In yet another embodiment, a non-transitory computer-readable medium storing instructions that, when executed by a computer, perform a process for feature detection in images. The process can include receiving an input image, processing the input image through a convolutional neural network to detect features within the image, cross-referencing the detected features with a stored database of features, and providing an indication of the presence of specific features detected in the input image.

In a further embodiment, an image recognition system configured to receive image data from a plurality of sources, apply one or more image preprocessing techniques to enhance the image data, use a deep learning algorithm to analyze the preprocessed image data to identify characteristic features, compare these features with a predefined library of image features to ascertain matches, and generate and transmit a report based on the analysis, wherein the report may include identification of objects, scenes, or activities depicted in the images.

In some embodiments, the system for processing and rendering emotional responses based on input audio and video streams can be implemented into by not limited to US Air force, Army FORSECOM, Police Departments, Fire Departments, Port Authority, Mount Sinai 911 Impact, Unions, The National Guard Bureau, Department of Defense, Department of Homeland Security Customs Border Protection and the like.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A digital character emotion response system comprising:
a receiver configured to receive an audio stream and a video stream;
an audio processing module configured to process the audio stream by performing feature extraction and preprocessing of vocal characteristics;
a video processing module configured to process the video stream;
a fusion module configured to amalgamate features from the audio processing module and the video processing module to form a unified data representation; and
a machine learning module comprising a Long Short-Term Memory (LSTM) model configured to analyze the unified data representation to predict emotional states of a person and output these predictions with associated confidence scores;
a display module configured to interact with a user based on the predicted emotional states.

2. The system of claim 1, wherein the video processing module is configured to process the video stream by at least one of performing facial landmark detection, performing body language analysis, performing emotion timing, preprocessing, and vision-language model analysis.

3. The system of claim 1 further comprising a plurality of APIs to integrate a plurality of external tools into the interaction with the user.

4. The system of claim 1, wherein the fusion module is further configured to perform feature-level integration of the audio and video features.

5. The system of claim 1, wherein the fusion module is further configured to perform decision-level integration of the audio and video features.

6. The system of claim 1, wherein the machine learning module is configured to employ the LSTM model trained specifically to recognize emotional states including at least happiness, sadness, anger, and neutrality.

7. The system of claim 1, further comprising an output module configured to adjust a digital character's vocal and/or factial attributes based on the predicted emotional state.

8. The system of claim 1, wherein the video processing module captures sequential frames from the video stream at controlled intervals and builds a persistent visual memory with the captured sequential frames.

9. The system of claim 8, wherein the machine learning module is configured to recognize when the user asks a visual question and combines the visual memory with historical context to formulate a relevant response to the user's visual question.

10. A method for responding to human interactions in a digital character, the method comprising:
receiving an audio stream and a video stream;
processing the audio stream to extract features and preprocess vocal characteristics;
processing the video stream;
amalgamating the processed features to form a unified data representation;
using a Long Short-Term Memory (LSTM) model to analyze the unified data representation for predicting emotional states; and
outputting the emotional state predictions with confidence scores
interacting with a user based on the emotional state predictions.

11. The method of claim 10, wherein amalgamating the processed features includes performing feature-level integration of the audio and video features.

12. The method of claim 10, wherein amalgamating the processed features includes performing decision-level integration of the audio and video features.

13. The method of claim 10, further comprising adjusting a digital character's vocal, facial and/or body attributes based on the predicted emotional state.

14. The method of claim 10 further comprising:
detecting when the user asks a visual question;
capturing a high priority visual frame and performing vision-language model analysis of the high priority visual frame;
combining the vision-language model analysis with historical context to provide a relevant response to the user's visual question.

15. The method of claim 10 wherein the processing of the video stream comprises capturing sequential frames from the video stream at controlled intervals.

16. The method of claim 15 further comprising building a persistent visual memory from the captured sequential frames.

17. The method of claim 10 further comprising interacting with at least one external application based at least in part on the user's emotional state.

18. The method of claim 10 wherein the use speaks a first language and at least one of the audio and video stream includes inputs in a second language, wherein the emotional state predictions include data from the second language and the interaction with the user is in the first language.
